(19) United States
(12) Patent Application Publication
(10) Pub. No.: US 2011/0309088 A1
(43) Pub. Date: Dec. 22, 2011

(54) Utensil that is Decomposed Naturally and the Method for Making It

(76) Inventor: Chien-Hsin Chao, Xiushui Township (TW)

(21) Appl. No.: 12/819,310

(22) Filed: Jun. 21, 2010

(51) Int. Cl. A47G 19/00; B29C 45/46

(52) U.S. Cl. 220/574; 264/108

(57) ABSTRACT

A method for making a utensil includes a first step of placing and stirring a mixture containing a thermoplastic material of 20-60%, a bamboo fiber powder of 20-60% and an adjuvant of 10-20% to form an evenly distributed first blank, a second step of graining the first blank to form multiple grains with uniform sizes, a third step of baking the multiple grains to form a semi-product, and a fourth step of injection molding the semi-product to form a final product of the utensil. Thus, the utensil is made of the bamboo fiber powder so that the utensil will not consume the foodstuff of the natural resource.

### BACKGROUND OF THE INVENTION

1. Field of the Invention

The present invention relates to a household utensil, such as a dishware and the like, and, more particularly, to a utensil and the method for making the utensil.

2. Description of the Related Art

A conventional utensil comprises melamine resin and corn powder which are mixed together. However, the utensil is made of the corn material so that the melamine utensil will consume and waste the foodstuff of the natural resource. In addition, the utensil is made of the corn material so that the utensil has a higher price. Further, the utensil is made of the corn material so that the utensil easily produces bacteria and mildews.

### BRIEF SUMMARY OF THE INVENTION

In accordance with the first feature of the present invention, there is provided a utensil, comprising a thermoplastic material of 20-60%, a bamboo fiber powder of 20-60% and an adjuvant of 10-20%.

In accordance with the second feature of the present invention, there is provided a method for making a utensil, comprising a first step of placing and stirring a mixture containing a thermoplastic material of 20-60%, a bamboo fiber powder of 20-60% and an adjuvant of 10-20% to form an evenly distributed first blank, a second step of graining the first blank to form multiple grains with uniform sizes, a third step of baking the multiple grains to form a semi-product, and a fourth step of injection molding the semi-product to form a final product of the utensil.

The primary objective of the present invention is to provide a utensil that is decomposed naturally to achieve an environmental protection purpose and has energy-saving and carbon reduction functions.

According to the primary advantage of the present invention, the bamboo fiber powder and the adjuvant are made of organic material so that the utensil can be decomposed naturally and will not pollute the environment when it is disposed of so as to achieve the environmental protection purpose.

According to another advantage of the present invention, the utensil is made of the bamboo fiber powder so that the utensil will not consume the foodstuff of the natural resource.

According to a further advantage of the present invention, the utensil is made of the bamboo fiber powder instead of the trees to prevent the forest from being logged and exhausted.

According to a further advantage of the present invention, the utensil can be heated by a microwave oven.

According to a further advantage of the present invention, the utensil is resistant to heat and is not deformed easily.

According to a further advantage of the present invention, the utensil can be reused and recycled when it is wasted to make a wooden board, sheet material, furniture, fence, vase, pot, kitchen ware, chopping board, sound, computer table and the like.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a front cross-sectional view of a utensil in accordance with the preferred embodiment of the present invention.

FIG. 2 is a flow chart of a method for making the utensil as shown in FIG. 1.

### DETAILED DESCRIPTION OF THE INVENTION

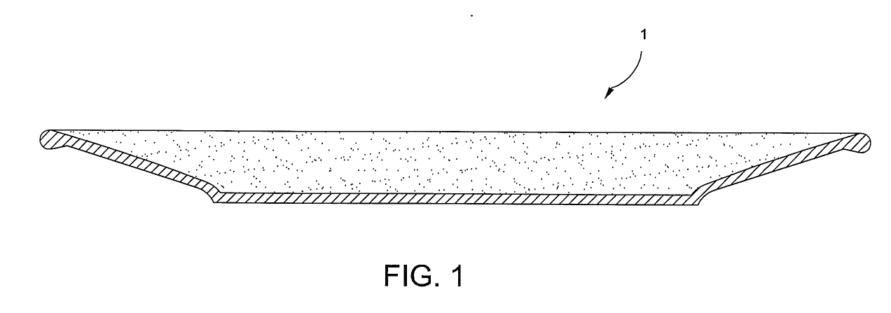

Referring to the drawings and initially to FIG. 1, a utensil 1 in accordance with the preferred embodiment of the present invention comprises a thermoplastic material 10 of 20-60%, a bamboo fiber powder 12 of 20-60% and an adjuvant 14 of 10-20%.

In the preferred embodiment of the present invention the thermoplastic material 10 is made of PP (polypropylene), PE (polyethylene), PS (polystyrene) or ABS (acrylonitrile butadiene styrene). The bamboo fiber powder 12 is made of an organic material. The bamboo fiber powder 12 has greater strength and malleability. The adjuvant 14 is made of an organic material. The adjuvant 14 has an adhesive feature.

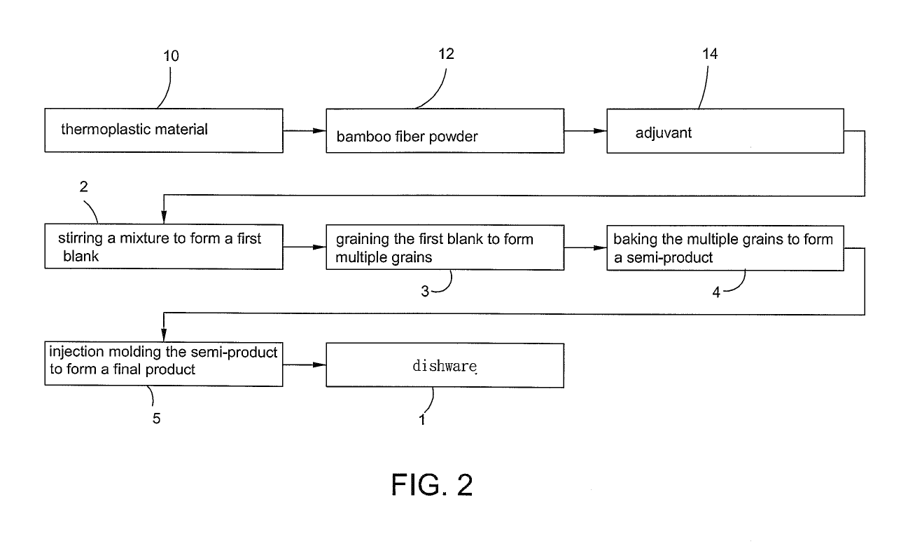

Referring to FIG. 2, a method for making a utensil 1 in accordance with the preferred embodiment of the present invention comprises a first step of placing and stirring a mixture containing a thermoplastic material 10 of 20-60%, a bamboo fiber powder 12 of 20-60% and an adjuvant 14 of 10-20% to form an evenly distributed first blank 2, a second step of graining the first blank 2 to form multiple grains 3 with uniform sizes, a third step of baking the multiple grains 3 to form a semi-product 4, and a fourth step of injection molding the semi-product 4 to form a final product of the utensil 1.

In the first step, the mixture is placed into and stirred evenly in a stirring barrel that is operated at a high speed. In addition, in the first step, the mixture is stirred at a temperature about 80° C. In the second step, the first blank 2 is placed into and stirred by a grainer that is operated at a high speed to roll and cut the first blank 2 into the multiple grains 3. In the third step, the multiple grains 3 are placed into and baked in an oven. In addition, in the third step, the semi-product 4 is formed at a temperature about 100 to 150° C. In the fourth step, the semi-product 4 is placed into and molded in an injection molding machine to form the final product of the utensil 1. In addition, in the fourth step, the semi-product 4 is molded at a temperature about 150° C.

Accordingly, the bamboo fiber powder 12 and the adjuvant are made of organic material so that the utensil 1 can be decomposed naturally and will not pollute the environment when it is disposed of so as to achieve the environmental protection purpose. In addition, the utensil 1 is made of the bamboo fiber powder 12 so that the utensil 1 will not consume the foodstuff of the natural resource. Further, the utensil 1 is made of the bamboo fiber powder 12 instead of the trees to prevent the forest from being logged and exhausted.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A utensil, comprising:
a thermoplastic material of 20-60%;
a bamboo fiber powder of 20-60%; and
an adjuvant of 10-20%.

2. The utensil of claim 1, wherein the thermoplastic material is made of PP (polypropylene).

3. The utensil of claim 1, wherein the thermoplastic material is made of PE (polyethylene).

4. The utensil of claim 1, wherein the thermoplastic material is made of PS (polystyrene).

5. The utensil of claim 1, wherein the thermoplastic material is made of ABS (acrylonitrile butadiene styrene).

6. The utensil of claim 1, wherein the adjuvant is made of an organic material and has an adhesive feature.

7. A method for making a utensil, comprising:
a first step of placing and stirring a mixture containing a thermoplastic material of 20-60%, a bamboo fiber powder of 20-60% and an adjuvant of 10-20% to form an evenly distributed first blank;
a second step of graining the first blank to form multiple grains with uniform sizes;
a third step of baking the multiple grains to form a semi-product; and
a fourth step of injection molding the semi-product to form a final product of the utensil.

8. The method for making a utensil of claim 7, wherein in the first step, the thermoplastic material is made of PP (polypropylene).

9. The method for making a utensil of claim 7, wherein in the first step, the thermoplastic material is made of PE (polyethylene).

10. The method for making a utensil of claim 7, wherein in the first step, the thermoplastic material is made of PS (polystyrene).

11. The method for making a utensil of claim 7, wherein in the first step, the thermoplastic material is made of ABS (acrylonitrile butadiene styrene).

12. The method for making a utensil of claim 7, wherein in the first step, the mixture is placed into and stirred evenly in a stirring barrel that is operated at a high speed.

13. The method for making a utensil of claim 7, wherein in the first step, the mixture is stirred at a temperature about 80° C.

14. The method for making a utensil of claim 7, wherein in the second step, the first blank is placed into and stirred by a grainer that is operated at a high speed to roll and cut the first blank into the multiple grains.

15. The method for making a utensil of claim 7, wherein in the third step, the multiple grains are placed into and baked in an oven.

16. The method for making a utensil of claim 7, wherein in the third step, the semi-product is formed at a temperature about 100 to 150° C.

17. The method for making a utensil of claim 7, wherein in the fourth step, the semi-product is placed into and molded in an injection molding machine to form the final product of the utensil.

18. The method for making a utensil of claim 7, wherein in the fourth step, the semi-product is molded at a temperature about 150° C.
